(19) United States
(12) Patent Application Publication
(10) Pub. No.: US 2011/0259209 A1
(43) Pub. Date: Oct. 27, 2011

(54) FILLING EXTRUDING MACHINE WITH SWITCHABLE HORIZONTAL AND VERTICAL FEEDER PATHS FOR MAKING THREE-LAYER FILLED FOOD PRODUCTS

(76) Inventor: Lien-Fu HUANG, Bali Township (TW)

(21) Appl. No.: 12/764,465

(22) Filed: Apr. 21, 2010

(51) Int. Cl. A23P 1/12

(52) U.S. Cl. 99/450.7

(57) ABSTRACT

A filling extruding machine for making three-layer filled food products is provided. Three independent materials, namely an outer material, an intermediate material, and an inner material, are simultaneously fed by three feeding mechanisms, respectively, and then output and clipped into three-layer filled food products. The filling extruding machine is characterized in that a central guide column, which is connected to a horizontal feeder and a vertical feeder, can have its orientation changed by 180 degrees so as to switch the feeding positions of the outer material and the intermediate material and thereby eliminate the need to change the contents of the feeders.

### BACKGROUND OF THE INVENTION

1. Technical Field

The present invention relates to a filling extruding machine which is configured for making three-layer filled food products and has switchable horizontal and vertical feeder paths so that three independent materials, namely an outer material, an intermediate material, and an inner material, can be simultaneously fed, output, and clipped into filled food products having three layers of materials. The filling extruding machine is characterized in that a central guide column, which is connected to a horizontal feeder and a vertical feeder, can have its orientation changed in order to switch the materials that are output as the outer material and the intermediate material, thereby eliminating the need to change the contents of the feeders.

2. Description of Related Art

Filled food products generally have two layers, i.e., a pastry layer made typically of dough and a filling wrapped therein, so as to provide enhanced texture and flavors. Basically, the material feeding mechanisms used in making two-layer filled food products are either two vertical feeders or two horizontal feeders from which the outer material and the inner material are pushed out respectively by screws. The output materials are then clipped and molded to form the desired two-layer filled food products.

Recently, three-layer filled food products have been successfully developed to bring the art of filled food to a higher level. With an outer pastry layer and two layers of differently flavored fillings, three-layer filled food products are further enhanced in texture and taste. To make three-layer filled food products, the inner material is supplied by a vertical feeder while the intermediate material and the outer material are pushed out by screws from two vertical or horizontal feeders, respectively. Then, the output materials are clipped and molded into the desired three-layer filled food products.

As is well known in the art, the outer material and the intermediate/inner material of a two- or three-layer filled food product usually have totally different characteristics. For instance, the outer pastry layer is different from the filling(s) in both hardness and flexibility. Therefore, if the different materials are fed by feeding mechanisms having the same design, the characteristics of the materials may be adversely affected, and moreover, the materials may be fed unevenly, thus leading to inconsistent product weight.

### BRIEF SUMMARY OF THE INVENTION

Motivated by the aforesaid drawbacks of the conventional filling extruding machines for making two- or three-layer filled food products, the inventor of the present invention put years of practical experience into research and experiment and finally succeeded in developing a filling extruding machine with switchable horizontal and vertical feeder paths for making three-layer filled food products. The present invention at least involves the following inventive steps:

1. While the inner material is still fed vertically as in the conventional manner, a vertical feeder and a horizontal feeder are provided on the left and right sides of the machine, respectively, for feeding the outer and intermediate materials. Thus, the different characteristics of the outer, intermediate, and inner materials can all be taken into account to meet quality requirements.

2. A central guide column is connected to the horizontal feeder and the vertical feeder and can be fixed in two different orientations that differ by 180 degrees. In addition, the central guide column is installed therein with a guide tube having a unidirectional opening. Therefore, the materials output as the outer material and the intermediate material can be easily switched by changing the orientation of the central guide column, without having to change the contents of the feeders.

3. The horizontal feed of the machine is implemented via two separate driving systems and two compression systems. More specifically, the horizontal feeder is provided therein with a two-screw compression feeding structure and has an end mounted with a pressure-enhanced tumbling rod, wherein the pressure-enhanced tumbling rod is independently driven and peripherally provided with a plurality of tumbling blades. Hence, smooth feeding is ensured jointly by the two-screw compression and the pressure-enhanced tumbling action.

4. A left guiding device is provided between the vertical feeder and the central guide column, and a right guiding device between the horizontal feeder and the central guide column. Each of the left and right guiding devices is installed therein with a tumbling rod which is peripherally provided with tumbling blades, so as to guide the outer material and the filling from the horizontal and vertical feeders into the central guide column evenly and smoothly.

### BRIEF DESCRIPTION OF THE SEVERAL VIEWS OF THE DRAWINGS

The invention as well as a preferred mode of use and the advantages thereof will be best understood by referring to the following detailed description of an illustrative embodiment in conjunction with the accompanying drawings, in which:

FIG. 1 is a left perspective view of the present invention;

FIG. 2 is a right perspective view of the present invention;

FIG. 3 is a left perspective view of the main structure of the present invention;

FIG. 4 is a right perspective view of the main structure of the present invention;

FIG. 5 is a partially exploded perspective view of the main structure of the present invention;

FIG. 6 is another partially exploded perspective view of the main structure of the present invention;

FIG. 7 is a perspective view of a central guide column and guiding devices of the present invention;

FIG. 8 is a sectional view showing operation of the main structure of the present invention;

FIG. 9 is a sectional view showing operation of the central guide column of the present invention; and

FIG. 10 is a sectional view showing operation of the central guide column of the present invention after the central guide column is rotated to a different position from that shown in FIG. 9.

### DETAILED DESCRIPTION OF THE INVENTION

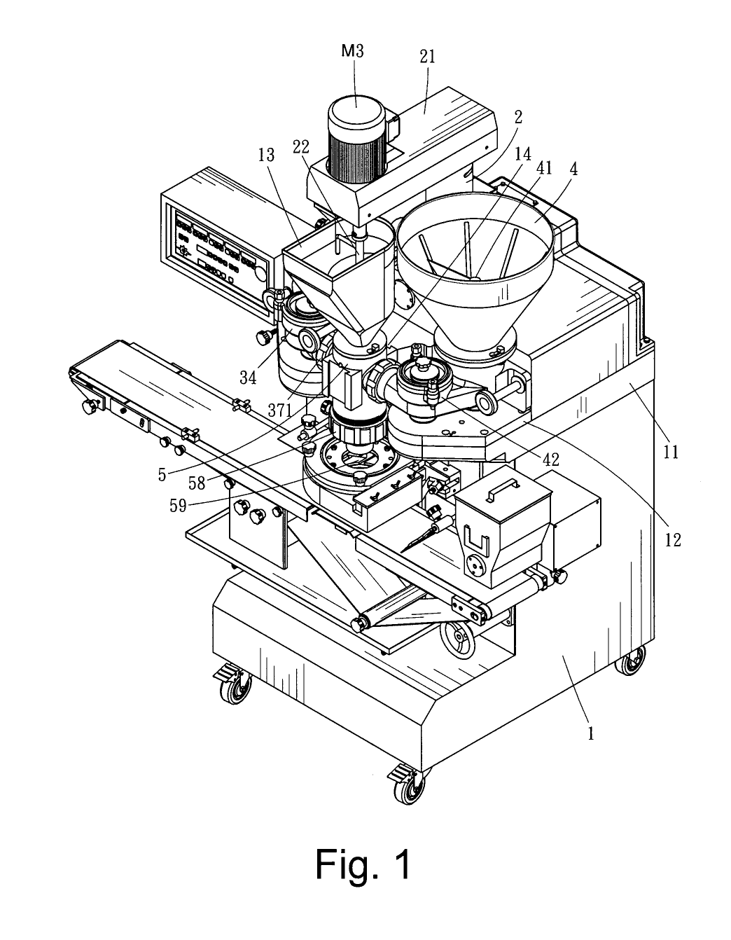

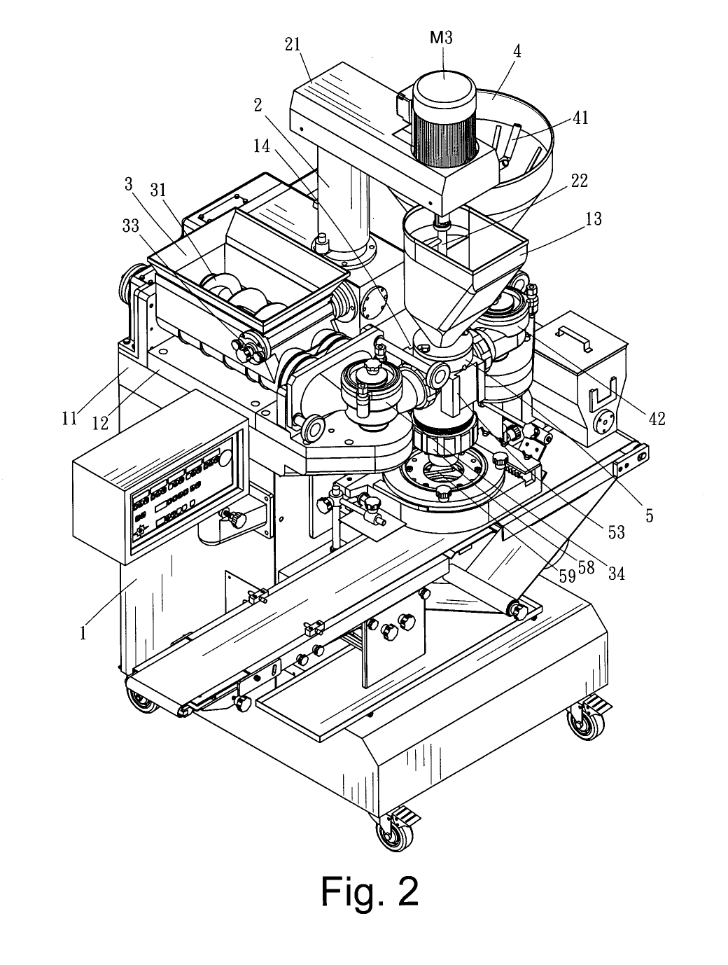

Referring to FIG. 1 and FIG. 2 for an embodiment of the present invention, a filling extruding machine with switchable horizontal and vertical feeder paths for making three-layer filled food products includes a transmission box 11 disposed on top of a support 1. Driving motors M1, M2 are bilaterally provided below the transmission box 11 while an upper cover 12 sits above the transmission box 11. A plurality of transmission gears and transmission mechanisms are provided inside the transmission box 11 and connected to the driving motors M1, M2. A vertical column 2 is located above the upper cover 12 and adjacent to the center thereof. A horizontal feeder 3 and a vertical feeder 4 are bilaterally provided above the upper cover 12. A beam 21 extending above the vertical column 2 has an end mounted with a driving motor M3. A screw 22 extends downward from the main shaft of the driving motor M3 into a central feeder 13. A driving motor M4 is disposed below the vertical column 2.

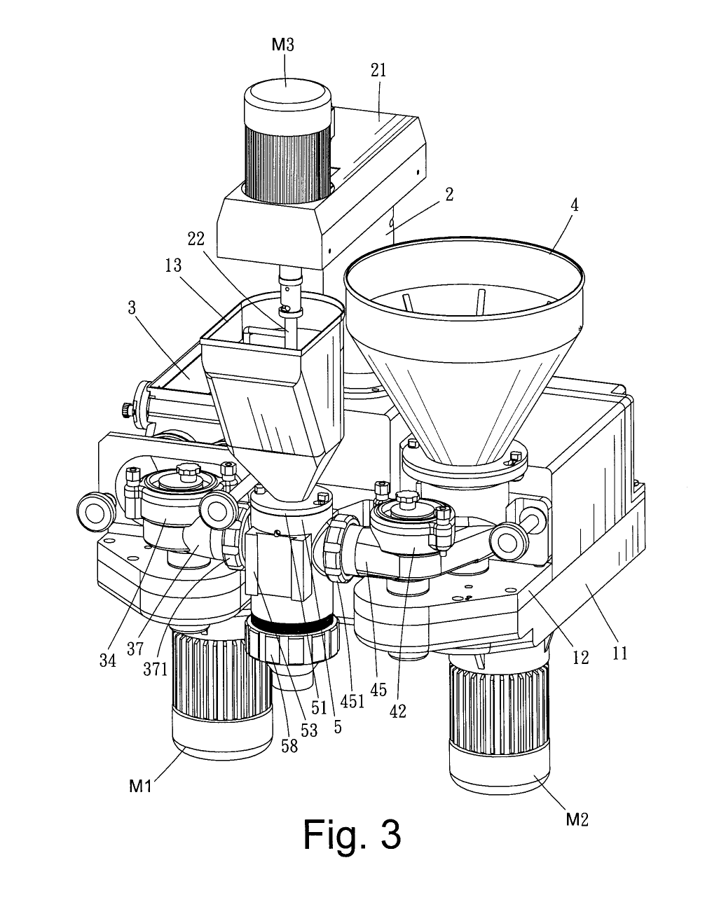

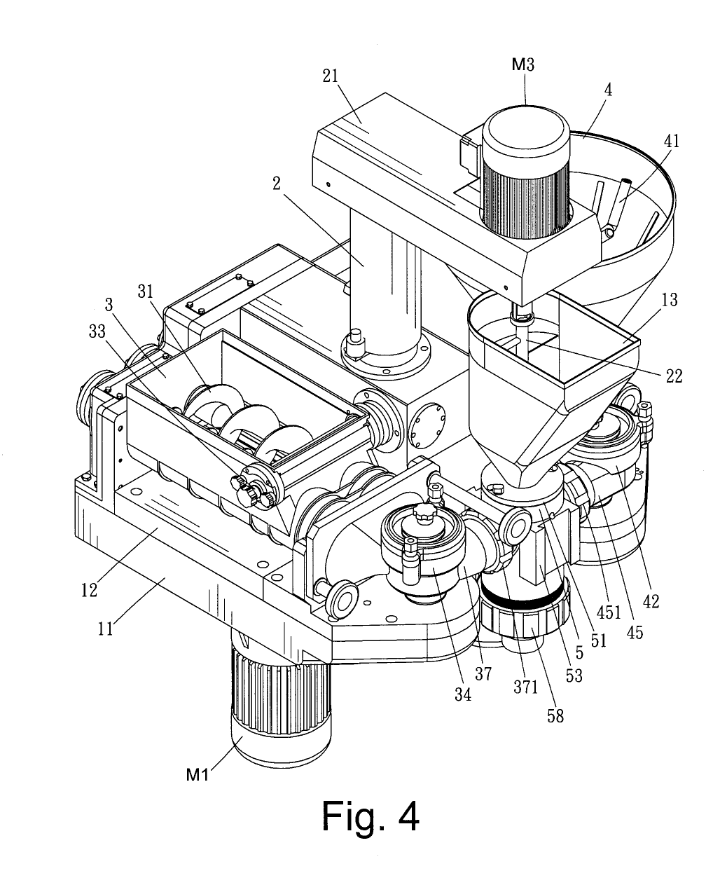

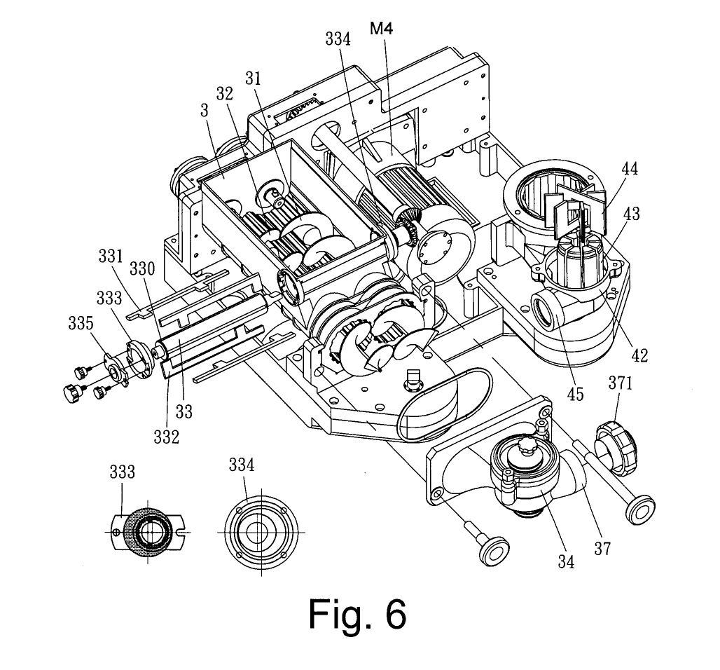

Referring to FIG. 3 and FIG. 4, the horizontal feeder 3 is provided therein with two screws 31, 32 which are coupled to and driven by the driving motor M1. A pressure-enhanced tumbling rod 33 is provided at the output end of the horizontal feeder 3. As shown more clearly in FIG. 6, the pressure-enhanced tumbling rod 33 is longitudinally formed with cross-shaped slots 330 for receiving two pairs of symmetric tumbling blades 331, 332, respectively. Moreover, eccentric orbit rings 333, 334 are mounted around the two ends of the pressure-enhanced tumbling rod 33, respectively, wherein the eccentric orbit ring 333 is further assembled with an eccentric orbit seat 335. Therefore, when the pressure-enhanced tumbling rod 33 is rotated, the symmetric tumbling blades 330, 331 press against each other to provide an enhanced tumbling effect.

The pressure-enhanced tumbling rod 33 is driven by the driving motor M4 located below the vertical column 2. Thus, the two screws 31, 32 in the horizontal feeder 3 and the pressure-enhanced tumbling rod 33 are driven by separate motors, with a view to pushing forward the dough or filling in the horizontal feeder 3 in an even and effective way.

The vertical feeder 4 is provided therein with a screw 41. The screw 41 is coupled to the driving motor M2 so as to be driven thereby.

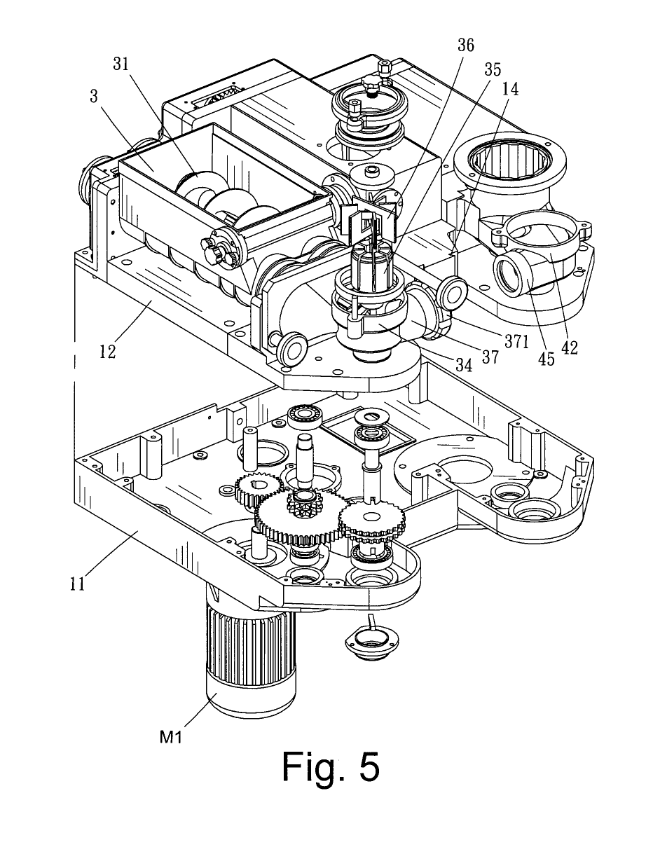

As shown in FIG. 5 to FIG. 7, the output ends of the horizontal feeder 3 and the vertical feeder 4 are connected to and in communication with the input ends of guiding devices 34, 42, respectively. The guiding devices 34, 42 are provided therein with tumbling rods 35, 43, respectively, and the tumbling rods 35, 43 are peripherally provided with a plurality of tumbling blades 36, 44, respectively. Furthermore, the tumbling rods 35, 43 are driven by the transmission mechanisms connected to the driving motors M1, M2.

The guiding devices 34, 42 have output connecting tubes 37, 45 which are connected to and communicate with a central guide column 5. The central guide column 5 is a hollow tube whose upper end is covered by an upper cover plate 51 and fixedly mounted with the central feeder 13 such that the central guide column 5 is in communication with the central feeder 13. Also, the central guide column 5 is externally and symmetrically provided with a pair of dovetail slots 52, 53. An outer guide tube 54 is placed and secured inside the central guide column 5. The outer guide tube 54 has a tube wall formed with a through hole 55. The through hole 55 corresponds in position to the output connecting tubes 37, 45 of the guiding devices 34, 42 and is in selective communication with one of the output connecting tubes 37, 45. Besides, a curved block 5A is provided on an inner surface of the central guide column 5 below the through hole 55. In addition, an inner guide tube 56 is placed and secured inside the outer guide tube 54. The inner guide tube 56 has an opening 57 in communication with the output hole at the bottom of the central feeder 13.

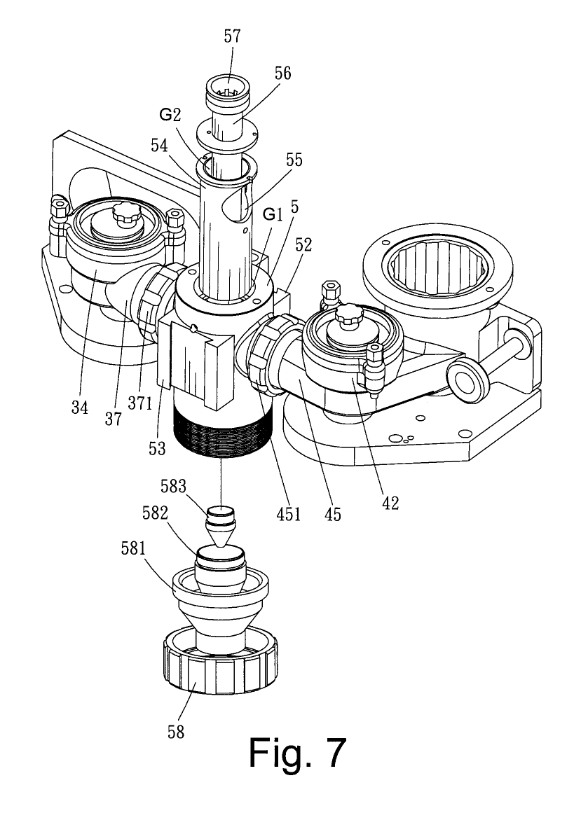

Referring to FIG. 7, inside the central guide column 5, a communication gap G1 is formed between the outer periphery of the outer guide tube 54 and the inner periphery of the central guide column 5, and a communication gap G2 is formed between the outer periphery of the inner guide tube 56 and the inner periphery of the outer guide tube 54. Thus, three independent materials, namely an outer material A, an intermediate material B, and an inner material C, can be guided into the central guide column 5 via the opening 57 of the inner guide tube 56, the communication gap G1, and the communication gap G2.

A threaded collar 58 is provided at the bottom of the central guide column 5 and configured for fixing an outer material guide column 581, an intermediate material guide column 582, and an inner material guide column 583 to the output end of the central guide column 5, thus allowing the outer material A, the intermediate material B, and the inner material C to be output concentrically from the bottom of the central guide column 5. The output materials are intermittently clipped by the underlying clipping dies 59 to form three-layer filled food products F.

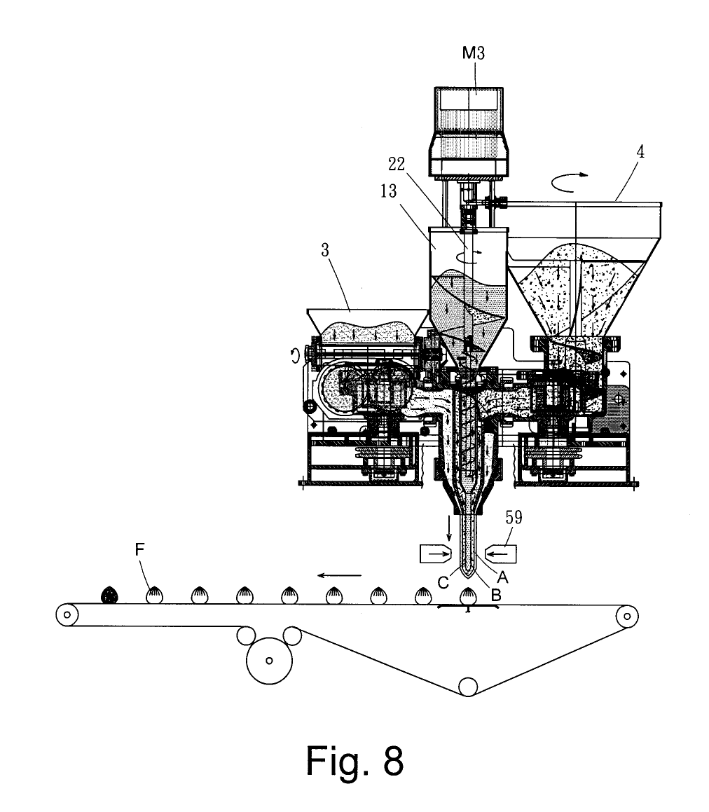

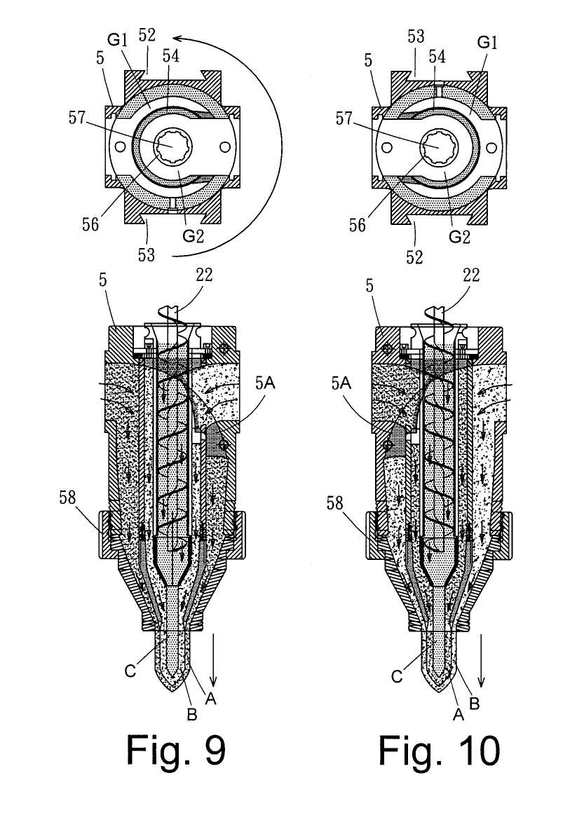

Referring to FIG. 5, the upper cover 12 of the transmission box 11 has a front end formed with a dovetail block 14 corresponding in position to the symmetrical pair of dovetail slots 52, 53 formed on the exterior of the central guide column 5. As shown in FIG. 8 to FIG. 10, the dovetail block 14 can selectively slide into and be fixed in position to one of the dovetail slots 52, 53, thus allowing the central guide column 5 to change its orientation by 180 degrees. As the outer guide tube 54 fixed inside the central guide column 5 has only one through hole 55, the through hole 5 and hence the communication gap G2 can be brought into communication with either the horizontal feeder 3 or the vertical feeder 4 by changing the orientation of the central guide column 5 by 180 degrees. Therefore, the positional relationship between the intermediate material B and the outer material A can be switched during production, and the feeding paths of the horizontal feeder 3 and the vertical feeder 4 easily switched, by changing the orientation of the central guide column 5 instead of changing the dough or filling inside the horizontal feeder 3 or the vertical feeder 4.

What is claimed is:

1. A filling extruding machine with switchable horizontal and vertical feeder paths for making three-layer filled food products, essentially comprising:
a transmission box disposed on a support, wherein a first driving motor and a second driving motor are bilaterally provided below the transmission box, an upper cover is provided above the transmission box and has a front end provided with a dovetail block, and a plurality of transmission gears and transmission mechanisms are provided in the transmission box and connected to the first and second driving motors;
a vertical column disposed above the upper cover and adjacent to a center thereof, wherein a beam extends above the vertical column and has an end provided with a third driving motor, a first screw extends downward from a main shaft of the third driving motor into a central feeder, and a fourth driving motor is provided below the vertical column;
a horizontal feeder disposed above the upper cover and on a side thereof, wherein the horizontal feeder is provided therein with two second screws connected to and driven by the first driving motor;
a vertical feeder provided above the upper cover and on a side thereof, wherein the vertical feeder is provided therein with a third screw connected to and driven by the second driving motor;
guiding devices which have input ends connected to an output end of the horizontal feeder and an output end of the vertical feeder, respectively, and which have output connecting tubes connected to and in communication with a central guide column; and
the central guide column formed as a hollow tube having an upper end, the upper end provided with an upper cover plate and fixedly mounted with the central feeder, the central guide column externally and symmetrically provided with a pair of dovetail slots, wherein an outer guide tube is disposed and fixed in the central guide column, and an inner guide tube is disposed and fixed in the outer guide tube, the outer guide tube having a tube wall formed with a through hole which corresponds in position to the output connecting tubes of the guiding devices and is in selective communication with one said output connecting tube, the inner guide tube having an opening in communication with an output hole at a bottom of the central feeder;
wherein the dovetail block at the front end of the upper cover is configured for selectively sliding into and being fixed in position to one of the dovetail slots of the central guide column, thus allowing an orientation of the central guide column to be changed by 180 degrees;
wherein by changing the orientation of the central guide column by 180 degrees, the sole through hole of the outer guide tube fixed in the central guide column, and hence a communication gap G2, are brought into communication with either the horizontal feeder or the vertical feeder; and
wherein a positional relationship between an intermediate material and an outer material is switchable during production, and feeding paths of the horizontal feeder and the vertical feeder easily switchable, by changing the orientation of the central guide column rather than changing a dough or a filling in the horizontal feeder or the vertical feeder.

2. The filling extruding machine of claim 1, wherein the horizontal feeder has an output end provided with a pressure-enhanced tumbling rod, the pressure-enhanced tumbling rod provided longitudinally with cross-shaped slots for receiving two pairs of symmetric tumbling blades, respectively, the pressure-enhanced tumbling rod having two ends each mounted with an eccentric orbit ring, in which one said eccentric orbit ring is mounted with an eccentric orbit seat such that when the pressure-enhanced tumbling rod is rotated, the symmetric tumbling blades press against each other to provide an enhanced tumbling effect.

3. The filling extruding machine of claim 1, wherein a tumbling rod is disposed in each said guiding device and peripherally provided with a plurality of tumbling blades, and the tumbling blades of the guiding devices are driven by the transmission mechanisms connected to the first and second driving motors.

4. The filling extruding machine of claim 1, wherein the central guide column has an inner surface provided with a curved block below the through hole, a first communication gap is formed between an outer periphery of the outer guide tube, which is configured as a hollow tube, and an inner periphery of the central guide column, and a second communication gap is formed between an outer periphery of the inner guide tube and the inner periphery of the outer guide tube, thus allowing three independent materials, namely an outer material, the intermediate material, and the outer material, to be guided into the central guide column via the opening of the inner guide tube, the first communication gap, and the second communication gap.

5. The filling extruding machine of claim 1, wherein the central guide column has a bottom provided with a threaded collar for securing an outer material guide column, an intermediate material guide column, and an inner material guide column to an output end of the central guide column, thus allowing an outer material, the intermediate material, and the outer material to be output concentrically from the bottom of the central guide column and intermittently clipped by underlying clipping dies so as to form the three-layer filled food products.
